(19) United States
(12) Patent Application Publication
(10) Pub. No.: US 2008/0022859 A1
(43) Pub. Date: Jan. 31, 2008

(54) Device for Producing a Brew of an Aromatic Vegetable Substance and Cartridge Containing Said Aromatic Vegetable Substance

(76) Inventor: Gian Carlo Marconi, Silea (IT)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/629,332

(22) PCT Filed: Apr. 19, 2005
(86) PCT No.: PCT/EP05/04141

§ 371 Date: Dec. 11, 2006

(30) Foreign Application Priority Data
Jun. 11, 2004 (IT) MI2004A001175

(51) Int. Cl. A47J 31/30

(52) U.S. Cl. 99/288

(57) ABSTRACT

Device (1) for preparing a brew of an aromatic vegetable substance by means of brewing through a cartridge (4) containing the aromatic vegetable substance, the device comprising a boiler (2) for the production of boiling water, a funnel (3) for housing the cartridge through which flows the boiling water for the production of the brew, a recipient (5) of the brew engaging with the boiler with the interposition of the funnel, first hydraulic sealing means (6) with the funnel and, distinct from the first hydraulic sealing means, second hydraulic sealing means (7) with the cartridge positioned perimetrically to the top filtering element (8) of the cartridge.

The present invention refers to a device for producing a brew of an aromatic vegetable substance and to a cartridge containing said aromatic vegetable substance. A device for producing a brew of coffee, in particular a traditional or electric percolator of the type comprising a boiler for producing boiling water, a funnel for housing coffee powder subjected to brewing by the boiling water sucked up from the boiler, and a recipient for the brewed coffee engaging with the boiler with the interposition of the funnel.

In such a traditional device the brewing chamber of the coffee powder is defined between a bottom filtering element applied inside the funnel and a top filtering element applied to the outside of the base of the recipient for the brew. The hydraulic seal of the brewing chamber is ensured by a gasket in use squashed against the free edge of the side wall of the funnel.

Sometimes in this same structure, instead of loose coffee powder a cartridge with filtering walls containing coffee powder is positioned in the brewing chamber. In any case, such a traditional device has a complex structure due essentially to the number of parts of which it consists, since it is necessary to apply a bottom filtering element in the funnel and a top filtering element on the outside of the base of the recipient in order to create the brewing chamber.

Moreover, the hydraulic seal of the brewing chamber is not perfectly ensured by the single sealing point against the free edge of the funnel made by the gasket.

The technical task proposed of the present invention is, therefore, that of making a device for producing a brew of an aromatic vegetable substance and a cartridge containing said aromatic vegetable substance that allow the aforementioned technical drawbacks of the prior art to be eliminated.

In this technical task a purpose of the invention is that of making a device for producing a brew of an aromatic vegetable substance and a cartridge containing said aromatic vegetable substance that allow a simplification in the structure and in the number of parts necessary for making the brewing chamber to be obtained.

Another purpose of the present invention is that of making a device for producing a brew of an aromatic vegetable substance and a cartridge containing said aromatic vegetable substance that ensure an optimal hydraulic seal of the brewing chamber in use.

The technical task, as well as these and other purposes, according to the present invention, are accomplished by making a device for producing a brew of an aromatic vegetable substance by means of brewing through a cartridge containing said aromatic vegetable substance, said device comprising a boiler for the production of boiling water, a funnel for housing said cartridge through which flows said boiling water for the production of said brew, and a recipient of said brew engaging with said boiler with the interposition of said funnel, characterised in that it has first hydraulic sealing means, second hydraulic sealing means with said cartridge able to be positioned perimetrically to the top filtering element of said cartridge.

The present invention also discloses a cartridge containing said aromatic vegetable substance able to be used in a device for preparing a brew of said aromatic substance, comprising a plastic cylindrical body closed by a bottom filtering element and by a top filtering element having a plurality of calibrated outlet holes, characterised in that said top filtering element has, on the outside, hydraulic sealing means comprising an annular projection circumscribing said plurality of calibrated outlet holes.

Other characteristics of the present invention are defined, moreover, in the other claims.

Further characteristics and advantages of the invention shall become clearer from the description of a preferred but not exclusive embodiment of the device and process for the preparation of a coffee-based drink according to the finding, where the device is illustrated for indicating and not limiting purposes in the attached drawings, in which:

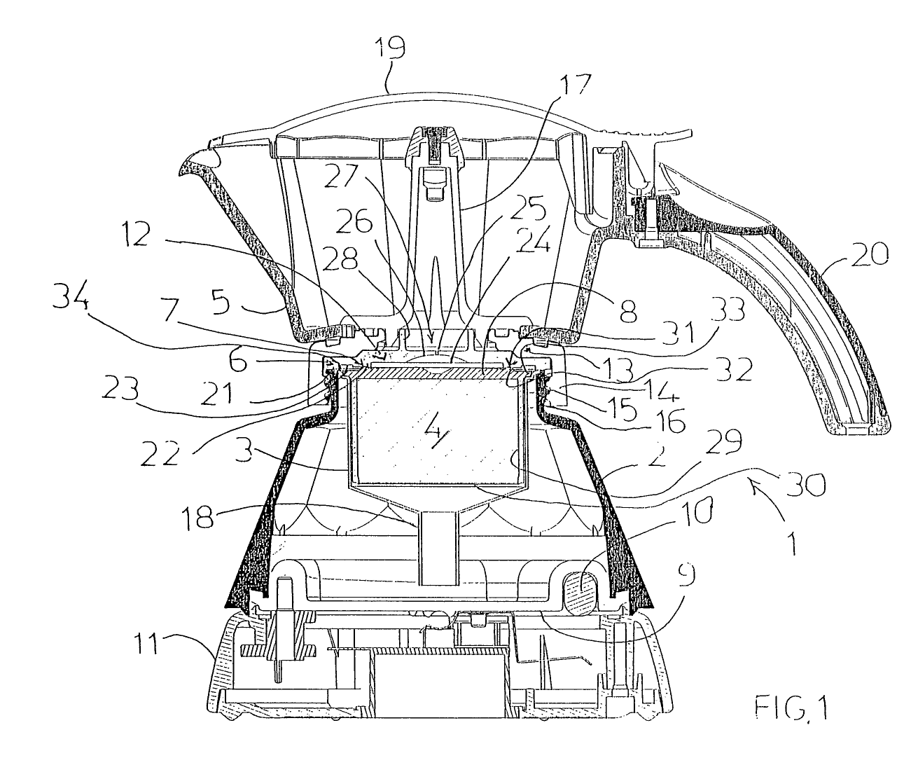

FIG. 1 shows a top side section view along the main axis of the device and of the cartridge according to a preferred embodiment of the finding; and

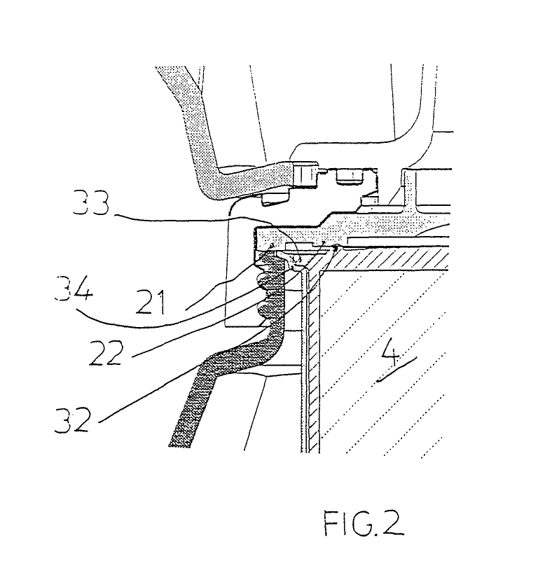

FIG. 2 shows an enlargement of a detail of the device of FIG. 1.

With reference to the quoted figures, a device for preparing a brew of an aromatic vegetable substance is shown, wholly indicated with reference numeral 1.

The device 1 comprises a boiler 2 for producing boiling water, a funnel for housing a cartridge 4 containing the aromatic vegetable substance, through which flows boiling water for producing the brew, and a recipient 5 for the brew engaging with the boiler 2 with the interposition of the funnel 3.

The recipient 5 has a base 13 that extends with a flange 14 having a threading 15 for coupling with a counter threading 16 of the mouth of the boiler 2.

The base 13 of the recipient 5 carries a substantially tubular dispenser 17 that extends inside the recipient 5 and pours the brew produced into the recipient 5.

The dispenser 17 is in fluid communication with the boiler 2 through the funnel 3.

The funnel 3 lies inside the boiler 2 and has one open side facing towards the dispenser 17 and one side facing towards the boiler 2 equipped with a water suction path 18.

A closing lid 19 and an ergonomic handle 20 are applied once again to the recipient 5.

In particular, in FIG. 1 the device 1 consists of an electric percolator.

The electric percolator includes an electrical resistance 10 for heating the water contained in the boiler 2 in the base 9 of the boiler 2.

The illustrated electric percolator is suitable for producing a brew of coffee, tea, camomile or something else according to the content of the cartridge 4.

The electrical resistance 10 is supplied with power by the plate 11 on which the base 9 of the boiler 2 rests.

Advantageously, the device 1 has first hydraulic sealing means 6 with the funnel 3 and, distinct from the first hydraulic sealing means 6, second hydraulic sealing means 7 with the cartridge 4 able to be positioned perimetrically to the top filtering element 8 of the cartridge 4.

Preferably, as illustrated, the first hydraulic sealing means 6 and the second hydraulic sealing means 7 are formed in a single body from a gasket 12.

The gasket 12 is associated with the side of the base 13 of the recipient 5 facing towards the boiler 2

In particular, the first sealing means 6 comprise a first radially outer annular protrusion 21 projecting from the side of the gasket 12 facing towards the boiler 2, whereas the second sealing means 7 comprise a second radially distanced annular protrusion 22 inside the first protrusion 21 and also projecting from the side of the gasket 12 facing towards the boiler 2.

The body of the gasket 12 has a reduction in thickness 23 at least in the zone between the first protrusion 21 and the second protrusion 22. This substantially makes an articulation that increases the flexibility of the gasket at that point and consequently allows the first protrusion 21 to adapt against the free edge of the side wall of the boiler 2 and the second protrusion 22 to adapt against the outer surface of the top filtering wall 8 of the cartridge 4 practically independently from each other.

The first hydraulic sealing means 6 and the second hydraulic sealing means 7 have sealing points arranged on different levels with respect to the axis of the device 1.

In particular, the first protrusion 21 and the second protrusion 22 of the gasket 12 have a different height so as to make a first sealing point between the gasket 12 and the free edge of the side wall of the boiler 2 and a second sealing point between the gasket 12 and the top filtering wall 8 of the cartridge 4, arranged radially inside and higher up with respect to the first sealing point.

The gasket 12, at the side facing towards the boiler 2 and in the zone radially inside the second protrusion 22, defines an elastically yielding pressurisation chamber 24 of the brew, having at least one calibrated through hole 25 in communication with the dispenser 17 and suitable for accelerating the flow of the brew so as to promote the encapsulation of air and the overall frothing of the brew.

The wall of the pressurisation chamber 24 has a narrowing in thickness 26 around the through holes 25 suitable for promoting its elastic deformation.

The gasket 12 has sealing engagement means 27 with the dispenser 17.

The sealing engagement means 27 comprise a third annular protrusion 28 that projects from the side of the gasket 12 facing towards the recipient 5 and circumscribes the calibrated through hole 25.

The cartridge 4 comprises a plastic cylindrical body 29 closed by a bottom filtering element 30 and by the top filtering element 8.

The top filtering element 8, preferably also made from plastic, has a plurality of calibrated outlet holes (not shown).

The bottom filtering element 30, on the other hand, preferably consists of one or more paper filtering layers. The top filtering element 8 has hydraulic sealing means 31 on its outside comprising an annular protrusion 32 circumscribing its calibrated outlet holes.

The hydraulic sealing means 31 of the top filtering element 8 of the cartridge 4 in use sealably engage with the second hydraulic sealing means 7.

In a possible different preferred embodiment the top filtering element 8 can also consist of one or more paper filtering layers in its portion radially inside the hydraulic sealing means 31.

Finally, the top filtering element 8 extends beyond the edge of the cylindrical body 30 with an annular flange 33 for resting against a counter-flange 34 of the free edge of the side wall of the funnel 3.

Advantageously, the annular flange 33 avoids the introduction of the cartridge 3 in the funnel 4 in upside-down position, because in this case it interferes with the counter-flange 34 before the cartridge 4 can be introduced in the funnel 3.

Advantageously, the flange 33 also rests directly against the counter-flange 34, whereas the bottom filtering element of the cartridge 4 is detached from the bottom of the funnel 3. This always ensures the correct operation of the first and second hydraulic sealing means, also making it possible to have a certain tolerance in the design of the height of the cartridge 4 and/or of the funnel 3.

The device 1 can comprise a control unit (not shown) suitable for controlling, amongst other things, a system for detecting the lack of water in the boiler 2.

The system for detecting the lack of water in the boiler 2 emits an alarm signal when the time of electrical power supply to the resistance 10 that has passed until the first deactivation intervention of a thermostat (not shown) that controls the power supply of the electrical resistance 10 is less than or equal to a predetermined threshold value.

The control unit is able to command the start or interruption of the power supply to the electrical resistance 10 and also has timing means suitable for interrupting the electrical power supply of the electrical resistance 10 after a predetermined time limit from the production of the brew; in practice, when the brew is ready the electrical power supply is not interrupted, it is only interrupted after a certain time period so as to keep the drink hot.

The operation of the device is briefly the following.

The cartridge 4 is introduced into the funnel 3 and the funnel 3 is positioned in the boiler 2, and then the recipient 5 is associated with the boiler 2.

The water, which when boiling is sucked from the boiler 2 by the path 18, through the bottom filtering wall 30 of the cartridge 4, and percolates through the content of the cartridge 4 making the brew.

The brew comes out from the top filtering wall 8 of the cartridge 4, is pressurised in the pressurisation chamber 24 and is accelerated at the calibrated outlet hole 25 to increase the air content and therefore the froth.

The brew thus reaches the dispenser 17 and from here is finally poured into the recipient 5.

During the production of the brew the hydraulic seal of the device 1 is ensured in at least three points by the contact pressure between the first protrusion 21 of the gasket 12 and the free edge of the side wall of the boiler 2, between the second protrusion 22 of the gasket 12 and the protrusion 32 of the top filtering wall 8 of the cartridge 4, and between the third protrusion 28 of the gasket 12 and the dispenser 17. In the last case it must be noted that an increase in the pressure in the chamber 24 results in an increase in the contact pressure between the third protrusion 28 of the gasket 12 and the dispenser 17 and overall a better seal.

It should be noted that the structure of the device for preparing a brew disclosed by the present finding advantageously does not have filtering elements carried by the outside of the base of the recipient of the brew and/or by the inside of the funnel for housing the cartridge, since the filtration is carried out by the bottom and top filtering elements of the cartridge.

The device and the cartridge thus conceived can undergo numerous modifications and variants, all of which are covered by the inventive concept; moreover, all of the details can be replaced with technically equivalent elements.

In practice, the materials used, as well as the sizes, can be whatever according to the requirements and the state of the art.

1. A device for preparing a brew of an aromatic vegetable substance by means of brewing through a cartridge containing said aromatic vegetable substance, said device comprising a boiler for the production of boiling water, a funnel for housing said cartridge through which flows said boiling water for the production of said brew, and a recipient of said brew engaging with said boiler with the interposition of said funnel, wherein said device also comprises a first hydraulic seal attached to said funnel and a second hydraulic seal positioned perimetrically to a top filtering element of said cartridge.

2. The device of claim 1 in which said first and second hydraulic seals comprise first and second sealing points arranged at different levels with respect to an imaginary vertical axis through said device.

3. The device of claim 1 in which said first and second hydraulic seals comprise a single body gasket.

4. The device of claim 1 comprising a filtering element, said filtering element consists essentially of a bottom and a top filtering member of said cartridge.

5. The device of claim 3 comprising said gasket associated with the side of the base of said recipient facing towards said boiler.

6. The device of claim 3 in which said first seal comprises a first radially outer annular protrusion projecting from the side of said gasket facing towards said boiler, and said second seal comprise comprises a second radially distanced annular protrusion inside said first protrusion and projecting from the side of said gasket facing towards said boiler.

7. The device of claim 3 wherein at least the body of said gasket has a reduction in thickness at least in the zone between said first and second protrusion.

8. The device of claim 6 comprising a height differential between said first protrusion and said second protrusion.

9. The device of claim 6 comprising said gasket, at the side facing towards said boiler and in the zone radially inside said second protrusion, further comprising an elastically yielding pressurisation chamber of said brew having at least one calibrated passageway in communication with a dispenser of said recipient and suitable for accelerating the flow of said brew so as to promote the encapsulation of air.

10. The device of claim 9 wherein a wall of said chamber comprises a narrowing in thickness around said passageway.

11. The device of claim 3 comprising said gasket in sealing engagement with the dispenser of said recipient.

12. The device of claim 11 wherein said sealing engagement comprises a third annular protrusion projecting from the side of said gasket facing towards said recipient, said third protrusion circumscribing at least one calibrated passageway.

13. The device of claim 1 wherein said device comprises an electric percolator.

14. The device of claim 1 wherein said cartridge comprises an aromatic vegetable substance to be used in a device for preparing a brew of said aromatic substance, said cartridge further comprises a plastic cylindrical body closed by a bottom filtering element and by a top filtering element having a plurality of calibrated outlet holes, wherein said top filtering element comprises, on the outside, said sealing engagement comprising an annular projection circumscribing said plurality of calibrated outlet holes.

15. The device of claim 14 wherein said cartridge comprising said bottom filtering element comprises one or more paper filtering layers.

16. The device of claim 14 wherein said cartridge comprises an annular support flange extending from said top filtering element beyond the edge of said cylindrical body.

17. A domestic appliance comprising a cartridge containing an aromatic vegetable substance, said cartridge comprising a plastic cylindrical body closed by a bottom filtering element and by a top filtering element having a plurality of calibrated outlet holes, and a device for preparing a brew of an aromatic vegetable substance by means of brewing through said cartridge, said device comprising a boiler for the production of boiling water, a funnel for housing said cartridge through which flows said boiling water for the production of said brew, and a recipient of said brew engaging with said boiler with the interposition of said funnel, wherein said top filtering element has a first hydraulic seal with said funnel and a second hydraulic seal with said cartridge positioned perimetrically to said top filtering element of said cartridge, and that said top filtering element has, on the outside, said sealing engagement comprising an annular projection circumscribing said plurality of calibrated outlet holes and sealably engaged with said second hydraulic seal.

18. (canceled)
